(19) United States
(12) Patent Application Publication
(10) Pub. No.: US 2006/0148510 A1
(43) Pub. Date: Jul. 6, 2006

(54) Cellular Phone as Universal Multimedia Storage Platform

(76) Inventor: Guobiao Zhang, Stateline, NV (US)

Correspondence Address: Dr.Guobiao Zhang, P.O. Box 6182, Stateline, NV, 89449-6182, US

(21) Appl. No.: 11/164,086

(22) Filed: Nov. 9, 2005

Related U.S. Application Data
(60) Provisional application No. 60/640,901, filed on Jan. 1, 2005.
(60) Provisional application No. 60/593,396, filed on Jan. 11, 2005.

(51) Int. Cl. H04M 1/00

(52) U.S. Cl. 455/550.1; 455/41.2

(57) ABSTRACT

The present invention discloses a cellular phone as universal multimedia storage platform (UMSP-phone). It comprises a high-speed, short-range wireless communication means for directly and seamlessly transferring data with multimedia devices (without computer or user intervention). UMSP-phone provides great user-convenience, while lowering the storage cost of its associated multimedia devices. It will become a personal communication, computation and storage hub.

### DESCRIPTION

This application is related to the following applications:

1. Provisional Application Ser. No. 60/640,901, “HDD-Wireless Phone”, Filed Jan. 1, 2005;

2. Provisional Application Ser. No. 60/593,396, “Hard-Disk-Drive-Based Dual-Range Wireless Phone”, Filed Jan. 11, 2005.

### BACKGROUND

1. Technical Field of the Invention

The present invention relates to the field of electronic systems, more particularly to cellular phones.

2. Prior Arts

Multimedia devices (MD) are devices that record and/or play multimedia (e.g. audio/video, i.e. A/V) data. They can be categorized into recording device (RD), playing device (PD) and multi-function device. The RD comprises at least a recording function, which converts external analog signals into multimedia data. Examples include digital still camera, digital camcorder, and digital voice recorder. The PD comprises at least a playing function, which converts multimedia data into perceptible analog signals. Examples include audio player (e.g. MP3-player), video player (e.g. portable DVD player), game machine (e.g. Nintendo DS), and global positioning system (GPS). Multi-function devices comprise both recording and playing functions. Examples include personal versatile recorder (PVR), camera (or video) phones with built-in MP3 player, and personal digital assistant (PDA). In the present invention, recording function and recording function are collectively referred to as multimedia functions.

Recently, the storage capacity of portable hard-disk drive (PHDD) increases tremendously: for 2.5″ PHDD, it has reached 120 GB (equivalent to ˜300 hours of MPE4 movies; ˜60,000 digital photos; or, ˜30,000 MP3 songs); for 1.8″ PHDD, it has reached 80 GB (equivalent to ˜200 hours of MPEG4 movies; ˜40,000 digital photos; or, ˜20,000 MP3 songs). If it is only used for a single multimedia application, the huge capacity of a PHDD will be wasted. Only when shared by a large number of MD's, will the PHDD capacity be fully exploited.

Kobayashi et al. and Poo et al. disclose in U.S. Patent Applications US2003/0045327A1, US2004/0225762A1 a pHDD-based wireless storage device. It comprises a wireless communication means for transferring data with at least an MD. Although this device provides a user with huge storage space, considering that the user's pocket has been fully occupied by “portable” devices such as cellular phone and MP3-player, this additional device will make the situation worse. It would be highly desirable to integrate this device with another device which is common to all users. Apparently, cellular phone is a right choice. Accordingly, the present invention discloses a cellular phone as universal multimedia storage platform (UMSP-phone).

### OBJECTS AND ADVANTAGES

It is a principle object of the present invention to provide a cellular phone as a personal communication, computation and storage hub.

It is another object of the present invention to lower the storage cost of multimedia devices.

In accordance with these and other objects of the present invention, a portable a cellular phone as universal multimedia storage platform (UMSP-phone) and its associated multimedia devices are disclosed.

### SUMMARY OF THE INVENTION

The present invention discloses a cellular phone as universal multimedia storage platform (UMSP-phone). It is based on portable hard-disk drive (PHDD) and comprises a wireless (or wired) communication means for directly transferring data with at least one multimedia device (MD). Here, the word “directly” means data transfer is not controlled by a computer and a user does not need to bring a computer when he uses a UMSP-phone and MD—a great user convenience.

The PHDD, more particularly 1.8″ PHDD, strikes a great balance in storage capacity, size and other parameters. It has a great capacity (80 GB), small size and weight (54×78.5×5 mm³, 62 g), high speed (100 MB/s) and low price (˜$100). Compared with portable DVD-player (too bulky), tape-recorder (serial read/write), flash memory (small capacity), PHDD is more suitable as universal multimedia storage platform. The UMSP-phone can replace various storage media (e.g. removable flash cards such as CF, MM, SD, MS, xD cards; videotapes such as VHS, 8 mm, Hi8, MiniDV, MicroMV; and optical discs such as CD, VCD, DVD) and put an end to the disordered storage standards.

The MD can generate (or consume) data at high rates. For example, digital camera generates data at no less than ˜10 Mb/s (even with built-in buffer); a digital video-player consumes data at no less than ˜1 Mb/s (for MPEG4 movies). Accordingly, UMSP-phone needs to comprise a high-speed (e.g. ≧1 Mb/s, typically ≧10 Mb/s) communication means with the MD. Moreover, because both the UMSP-phone and MD use battery as power, this communication means needs to be lower-power.

A first preferred UMSP-phone is a wireless UMSP-phone. It comprises a high-speed, low-power wireless means for directly and seamlessly transferring data with a wireless multimedia device (wMD). Here, the word “seamlessly” means no user intervention is needed during data transfer, i.e. a user does not need to connect a wire between the phone and MD, or click on a keypad. Seamless data-transfer can be realized by improving the phone-firmware and wMD-firmware. It can significantly lower the wMD storage cost.

The wireless UMSP-phone needs to comprise a high-speed, low-power wireless communication means. In general, this requirement is difficult to satisfy. Fortunately, during normal usage, a user typically holds a wMD while the phone is placed in his pocket. The distance between the phone and wMD is small (e.g. ≦10 m, typically ≦3 m). To realize ≧1 Mb/s (preferably ≧10 Mb/s) speed at such a small distance is relatively easy. Many high-speed, short-range wireless means under development can satisfy this need, e.g. Bluetooth 2.0, Ultrawide band (UWB), wireless USB, wireless 1394. Compared with medium- to long-range wireless means (e.g. WiFi, CDMA), it is easier to design, has a faster speed, consumes less power and costs less. Notice that because wireless means is used, wireless UMSP-phone can simultaneously communicate with at least two wMD's.

Another preferred UMSP-phone is a hybrid UMSP-phone. Besides wireless means, it further comprises a wired communication means, e.g. USB, IEEE 1394 and Ethernet. Wired means is particularly advantageous for large-volume data transfer because it is faster and consumes less power. In addition, before wireless UMSP-phone is commercially realized, wired UMSP-phone (i.e. the UMSP-phone only comprises a wired means) is a practical intermediate step.

UMSP-phone combines the conventional cellular-phone with the storage device disclosed by Kobayashi et al. and Poo et al. As a result, many of their system resources (e.g. microprocessor, memory, battery, display and input) can be shared. This can significantly lower the overall system cost. In the near future, UMSP-phone will become a personal communication, computation and storage hub. Moreover, UMSP-phone may further comprise at least one multimedia function.

### BRIEF DESCRIPTION OF THE DRAWINGS

FIG. 1 illustrates the usage of a cellular-phone as universal multimedia storage platform (UMSP-phone);

FIGS. 2A-2B illustrate a preferred wireless UMSP-phone and its usage model;

FIGS. 3A-3D are different views of the preferred wireless UMSP-phone; FIG. 3E is a cross-sectional view of its PHDD (with front-cover removed);

FIG. 4 is a circuit block diagram of the preferred wireless UMSP-phone;

FIGS. 5A-5B illustrates two preferred wireless recording devices (wRD); FIG. 5C is a circuit block diagram of the preferred wRD; FIG. 5D illustrates a preferred data-transfer process between the wRD and UMSP-phone;

FIG. 6A illustrates a first preferred wireless playing devices (wPD); FIGS. 6B-6C illustrate a second preferred wPD; FIG. 6D is a circuit block diagram of the preferred wPD; FIG. 6E illustrates a preferred data-transfer process between the wPD and UMSP-phone;

FIG. 7A illustrates a preferred hybrid UMSP-phone (or wired UMSP-phone); FIG. 7B illustrates another preferred hybrid UMSP-phone (or wired UMSP-phone) with detachable PHDD (with PHDD taken out); FIGS. 7C-7G illustrate their usage models;

FIG. 8A is a circuit block diagram of the preferred hybrid UMSP-phone; FIG. 8B is a circuit block diagram of the preferred wired UMSP-phone;

FIG. 9 is a circuit-block diagram of a preferred UMSP-phone with at least one multimedia function.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

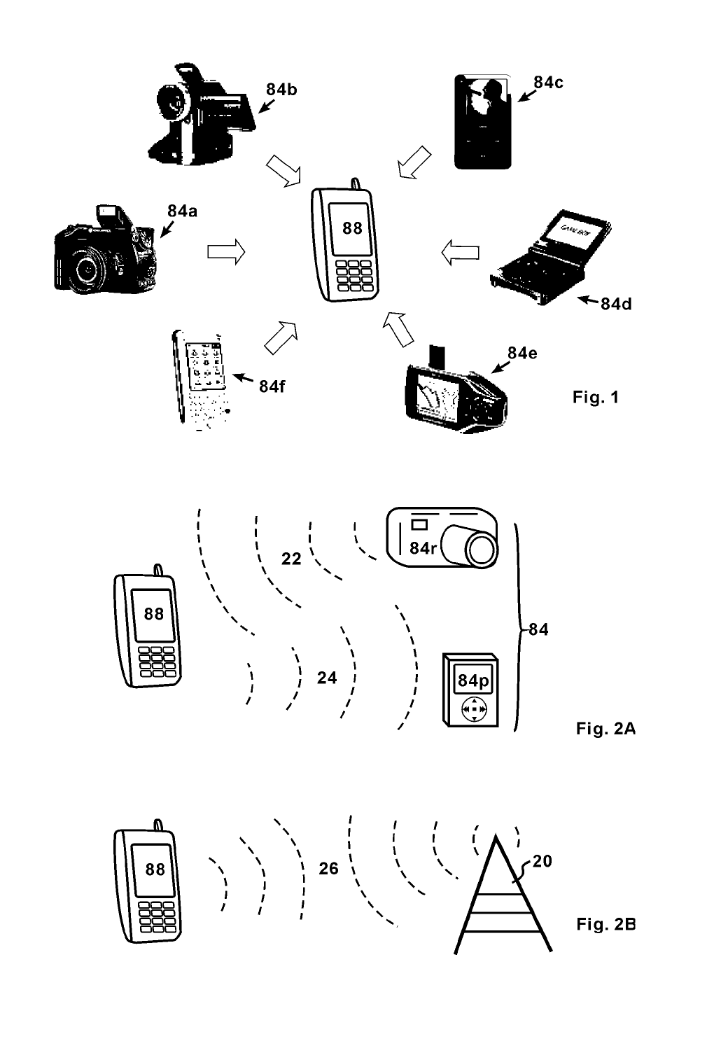

The present invention discloses a cellular phone as universal multimedia storage platform (UMSP-phone). It is based on portable hard-disk drive (PHDD) and comprises a wireless (or wired) communication means for directly transferring data with at least one multimedia device (MD), e.g. digital camera 84a, digital camcorder 84b, digital audio/video-player 84c, game machine 84d, global position system (GPS) 84e, personal digital assistant (PDA) 84f (FIG. 1). Here, the word “directly” means data transfer is not controlled by a computer and a user does not need to bring a computer when he uses a UMSP-phone and MD—a great user convenience.

In general, an “on-the-go” user wishes to access thousands of photos, thousands of songs, and at least tens of hours of movies. These are equivalent to ≧10 GB storage space. The portable hard-disk drive (pHDD), more particularly 1.8″ PHDD, strikes a great balance in storage capacity, size and other parameters. It has a great capacity (80 GB), small size and weight (54×78.5×5 mm³, 62 g), high speed (100 MB/s) and low price (˜$100). Compared with portable DVD-player (too bulky), tape-recorder (serial read/write), flash memory (small capacity), PHDD is more suitable as universal multimedia storage platform. This is why PHDD is chosen as the storage medium for the UMSP-phone. UMSP-phone can replace various storage media (e.g. removable flash cards such as CF, MM, SD, MS, xD cards; videotapes such as VHS, 8 mm, Hi8, MiniDV, MicroMV; and optical discs such as CD, VCD, DVD) and put an end to the disordered storage standards.

The MD can generate (or consume) data at high rates. For example, digital camera generates data at no less than ˜10 Mb/s (even with built-in buffer); a digital video-player consumes data at no less than ˜1 Mb/s (for MPEG4 movies). Accordingly, UMSP-phone needs to comprise a high-speed (e.g. ≧1 Mb/s, typically ≧10 Mb/s) communication means with the MD. Moreover, because both the UMSP-phone and MD use battery as power, this communication means needs to be lower-power.

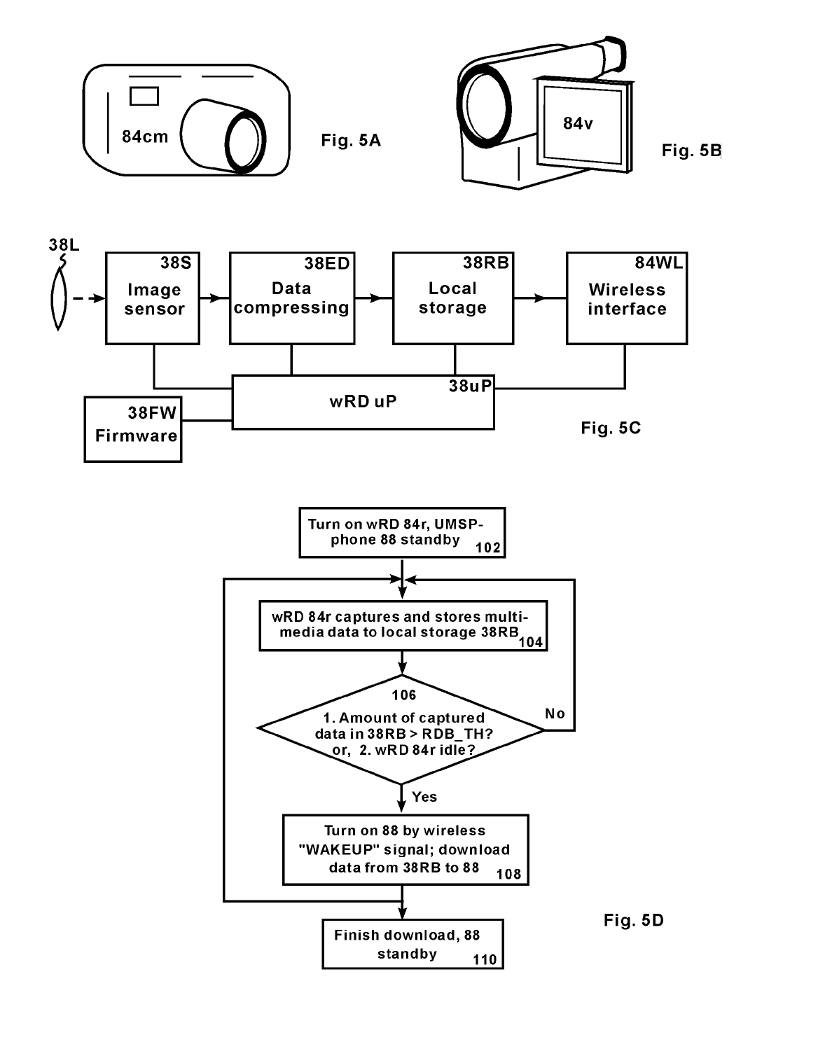

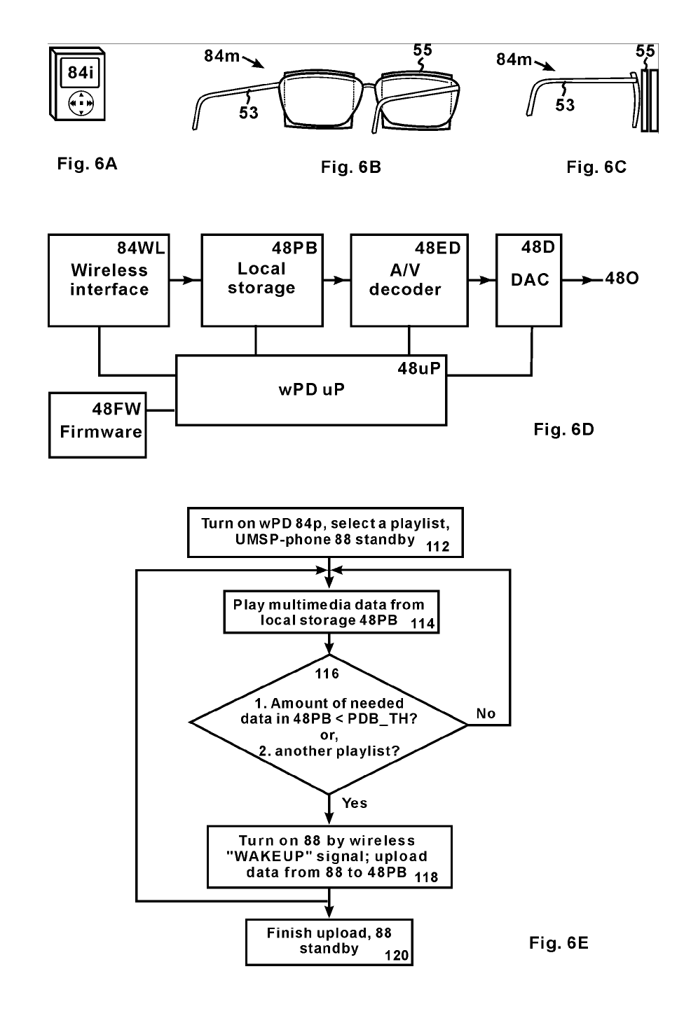

A first preferred UMSP-phone is a wireless UMSP-phone. It comprises a high-speed, low-power wireless means for directly and seamlessly transferring data with a wireless multimedia device (wMD). Here, the word “seamlessly” means no user intervention is needed during data transfer, i.e. a user does not need to connect a wire between the phone and MD, or click on a keypad. Seamless data-transfer can be realized by improving the phone firmware and wMD firmware. It can significantly lower the wMD storage cost (referring to FIG. 5D and FIG. 6E).

FIG. 2A illustrates a first preferred usage model of a wireless UMSP-phone—multimedia data transfer. To be more specific, it can directly and seamlessly download the captured data from a wireless recording device (wRD) 84r; or directly and seamlessly upload the needed data to a wireless playing device (wPD) 84p.

In theory, a cellular-phone based on the conventional Bluetooth (Bluetooth 1.0) technology seems to be able to realize the scenarios in FIG. 2A. However, because Bluetooth 1.0 has a low speed (˜0.72 Mb/s), it cannot satisfy the speed requirement from many multimedia devices (e.g. digital camera, digital camcorder, digital video-player). As a result, it cannot become universal multimedia storage platform.

In order to support high-speed MD's, the wireless UMSP-phone needs to comprise a high-speed, low-power wireless communication means. In general, this requirement is difficult to satisfy. Fortunately, during normal usage, a user typically holds a wMD while the phone is placed in his pocket. The distance between the phone and wMD is small (e.g. ≦10 m, typically ≦3 m). To realize ≧1 Mb/s (preferably ≧10 Mb/s) speed at such a small distance is relatively easy. Many high-speed, short-range wireless means under development can satisfy this need, e.g. Bluetooth 2.0, Ultrawide band (UWB), wireless USB, wireless 1394. Here, Bluetooth 2.0 is a short-range, low-power and low-cost wireless means, its transfer speed is 3.8-11.4 Mb/s; wireless USB is a short-range, low-power, low-cost and high-speed (as high as ˜480 Mb/s) wireless means, it may use UWB as PHY layer. Compared with medium- to long-range wireless means (e.g. WiFi, CDMA), short-range wireless means is easier to design, has a faster speed, consumes less power and costs less. Notice in FIG. 2A, because wireless means is used, the UMSP-phone 88 can simultaneously communicate with at least two wMD's 84r, 84p.

FIG. 2B illustrates another preferred usage mode of a wireless UMSP-phone 88—long-range communication. Long-range communication is the basic function of a cellular-phone 88, i.e. it communicates with a based station 20 using a wireless means. The range of this communication could be miles. As a result, its data rate is typically slow. Examples of long-range communication include CDMA, GSM.

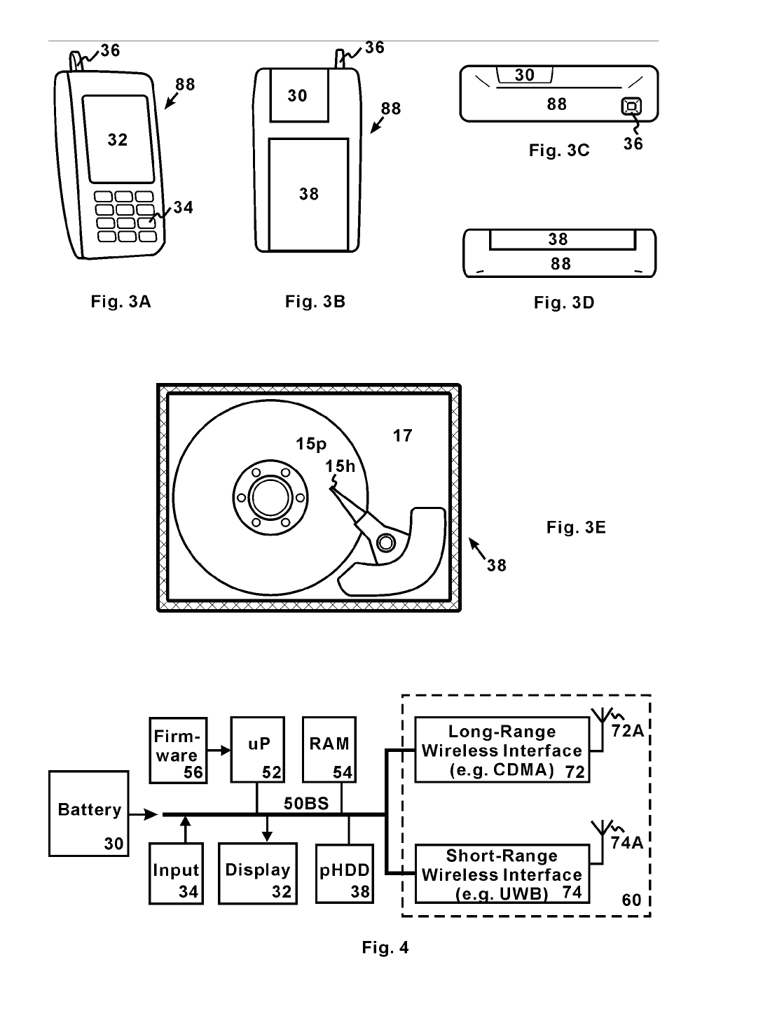

FIGS. 3A-3D are different views of the preferred wireless UMSP-phone. FIG. 3A is its front view. It comprises a display 32, input 34, and antenna 36. FIG. 3B is its back view. It further comprises a PHDD 38 and a battery 30. FIG. 3C is its top view. The battery 30 and antenna 36 can be seen here. FIG. 3D is its bottom view. The PHDD 38 can be seen here. FIG. 3E is a cross-sectional view of its PHDD (with front-cover removed) 38. It comprises a head-disk assembly (HDA) 17, which includes at least one disc-platter 15p and disc-head 15h. For pHDD, its disc-platter diameter is ≦2.5″, preferably around 1.8″; and its capacity is preferably ≧10 GB.

FIG. 4 is a circuit block diagram of the preferred wireless UMSP-phone 88. It comprises a microprocessor (uP) 52, phone-firmware 56 (usually in ROM), RAM 54, battery 30, display 32, input 34, PHDD 38 and interface 60. These circuit blocks communicate via the system bus 50BS. The uP 52 and phone-firmware 56 are the “heart” of the UMSP-phone 88. They enable direct and seamless communication between the phone 88 and wMD 84. The RAM 54 acts as a buffer for the PHDD 38. Its capacity is preferably large enough to enable “intermittent access” mode, which will be explained in the next paragraph. The interface 60 comprises a long-range wireless interface 72 and a short-range wireless interface 74. The long-range wireless interface 72 provides regular cellular communication via its antenna 72A; the short-range wireless interface 74 provides communication channel between the phone 88 and wMD 84 via its antenna 74A. One great advantage of the UMSP-phone 88 is that multimedia data-transfer system (short-range) and cellular communication system (long-range) can share many system resources, e.g. uP 52, memory 54, firmware 56, battery 30, display 32 and input 34. As a result, system costs will be lower.

The “intermittent access” mode can be applied to both read and write. During read, a large amount of data are read out once from the HDA 17 and stored in the buffer 54 first. While these data are read out piecewise at a later time, the HDA 17 stays at standby. During write, data are written to the buffer 54 first. Only when the buffer 54 is almost full, the HDA 17 is turned on and all data in the buffer 54 are written to the HDA 17 once. The “intermittent access” mode can shorten the running time of the HDA 17 and lower its power consumption, provided the following condition is satisfied:
S_{M}>E_{HDA}/{P_{HDA}*(1/R_{MD}−1/R_{HDA})},
where, S_{M} is the capacity of the buffer 54; E_{HDA} is the energy consumption to start the HDA 17; P_{HDA} is the power consumption during active read or write of the HDA 17; R_{MD} is the rate at which an MD 84 records or plays multimedia data; and R_{HDA} is the rate at which the HDA 17 reads or writes data.

FIGS. 5A-5B illustrate two preferred wireless recording devices (wRD) 84r. FIG. 5A is a wireless digital camera 84cm and FIG. 5B is a wireless digital camcorder 84v. They can both download the captured data to the UMSP-phone 88 through a wireless means. FIG. 5C is its circuit block diagram. It comprises a wRD uP 38uP, device-firmware 38FW, lens 38L, image sensor 38S, data compressing block 38ED, local storage 38RB and wireless interface 84WL. The wRD uP 38uP and device-firmware 38FW are the “heart” of the wRD 84r. They enable direct and seamless communication between the phone 88 and wRD 84r. The lens 38L, image sensor 38S and data compressing block 38ED capture and converts images into multimedia data. The local storage 38RB is used as a buffer for the wRD and it temporarily stores the multimedia data. The wireless interface 84WL provides data communication channel between the phone 88 and wRD 84r. Apparently, this circuit block diagram can also be applied to other wRD's, e.g. digital voice recorder.

FIG. 5D illustrates a preferred data-transfer process between a UMSP-phone 88 and a wRD 84r. It comprises the following A)-E) steps: STEP A) Turn on the wRD 84r; the UMSP-phone 88 stands by (step 102); STEP B) The wRD 84r captures multimedia data and store them in the local storage 38RB (step 104); STEP C) If the amount of data in the local storage 38RB exceeds a pre-determined threshold RDB_TH, or the wRD 84r becomes idle, then the wRD 84r sends out a wireless “WAKEUP” signal (step 106); STEP D) This signal activates the phone 88; data in the local storage 38RB are downloaded into the phone 88 (step 108); STEP E) Once data are downloaded, the UMSP-phone 88 goes back to standby (step 110).

FIGS. 6A-6C illustrate two preferred wireless playing devices (wPD) 84p. FIG. 6A is a preferred wireless MP3 player 84p and it can upload the needed audio data from a UMSP-phone 88 through a wireless means. FIGS. 6B-6C are the perspective and side views of a preferred microdisplay-based wPD. It comprises a microdisplay chip 55, which is mounted on an eyeglass structure 53. Microdisplay is a mature technology (referring to Wright et al. “Die-sized displays enable new applications”, Semiconductor International, September 1998). Being much lighter and smaller, microdisplay can form images as good as from conventional displays. The microdisplay-based player (wireless or wired) will make a revolutionary change to the video-watching experience, as much as the MP3 player did to the music-listening experience.

FIG. 6D is a circuit block diagram of the preferred wPD 84p. It comprises a wPD uP 48uP, device-firmware 48FW, wireless interface 84WL, local storage 48PB, A/V decoder 48ED, and D/A converter 48D. The wRD uP 48uP and device-firmware 48FW are the “heart” of the wPD 84p. They enable direct and seamless communication between the UMSP-phone 88 and wPD 84p. The wireless interface 84WL provides communication channel between the phone 88 and wPD 84p. The local storage 48PB acts as the buffer for the wPD and it temporarily stores multimedia data uploaded from the phone 88. The A/V decoder 48ED and D/A converter 48D decode and convert these multimedia data into analog outputs 48O. Apparently, this circuit block diagram can be applied to various wPD's, e.g. digital audio-player, digital video-player, game machine, GPS and PDA.

FIG. 6E illustrates a preferred data-transfer process between a UMSP-phone 88 and a wPD 84p. It comprises the following A)-E) steps: STEP A) Turn on the wDP 84p and select a playlist; the phone 88 stands by (step 112); STEP B) The wDP 84p plays multimedia data from the local storage 48PB (step 114); STEP C) If the amount of needed data in the local storage 48PB falls below a pre-determined threshold PDB_TH, or another playlist is selected, then the wPD 84p sends out a wireless “WAKEUP” signal (step 116); STEP D) This signal activates the phone 88, and then data are uploaded from the phone 88 (step 118); STEP E) Once data are uploaded, the UMSP-phone 88 goes back to standby (step 120).

The existing Bluetooth-based cellular-phone uses a manual method to initiate wireless data transfer with another Bluetooth-based device. To be more specific, the phone first shows the file list from the other device; then the user clicks on the input and selects one file; after receiving this file name, the device sends the file to the phone. Manual wireless data transfer requires the device have a local storage larger than the amount of data it records (or plays) during a user session. This will make the device storage cost high. Here, a user session is the interval between two user actions (e.g. connecting a wire between the phone and device, or clicking on a keypad of the phone or device).

By improving the phone-firmware 56 and device-firmwares 38FW, 48FW, the UMSP-phone 88 can automatically initiate wireless data transfer. To be more specific, when the amount of data in the wMD local storage (38RB, 48PB) reaches a pre-determined threshold (RDB_TH, PDB_TH), data transfer will automatically start (referring to steps 1 06, 108 in FIGS. 5D, and steps 116, 118 in FIG. 6E). As a result, a user does not need to manually start the data transfer (e.g. by clicking on a keypad). Combined with wireless means, seamless data transfer can be realized.

One important consequence of the seamless data transfer is that the wMD local storage (38RB, 48PB) can have a small capacity. To be more specific, it can be smaller than the amount of data that the wMD records (or plays) during a user session. Moreover, because it is used as a buffer (38RB, 48PB) for temporary data storage, the wMD local storage may use volatile memory (e.g. DRAM), not the more expensive non-volatile memory. In sum, the wMD local storage can have a small capacity and use a less-expensive memory. This can significantly lower the wMD storage cost.

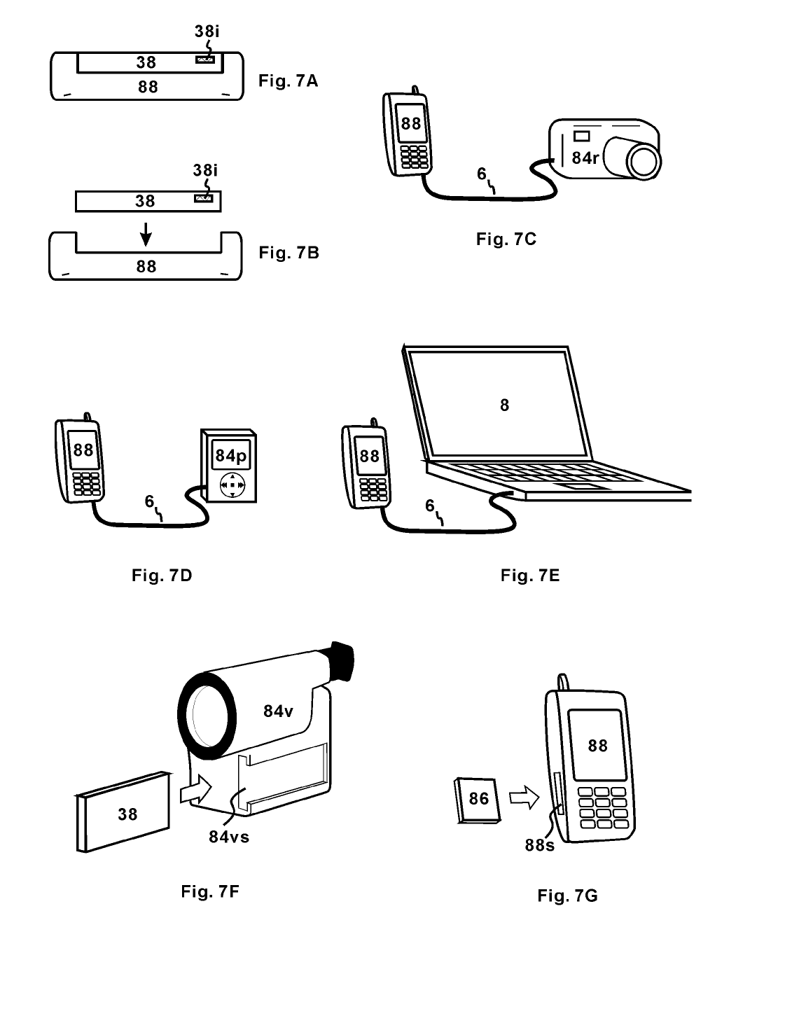

When a large amount of data (LGB) needs to be transferred, wired communication has advantages in speed and power consumption. Accordingly, the present invention discloses a hybrid UMSP-phone 88. It comprises both wireless and wired means. FIG. 7A is its bottom view. It comprises a wired interface 38i. This wired interface could be USB, IEEE 1394 or Ethernet. In FIG. 7B, the hybrid UMSP-phone 88 further comprises a detachable PHDD 38. In this preferred embodiment, the PHDD 38 is detached from the phone body. Apparently, the PHDD 38 may also be built inside the phone body.

The wireless usage model of the hybrid UMSP-phone is similar to FIGS. 2A-2B. On the other hand, its wired usage models include the following modes: phone-device, phone-computer, pHDD-device and phone-storage card. In the phone-device mode, data are directly transferred between the phone 88 and device 84 via a wire 6, for example, from an RD 84r (FIG. 7C), or to a PD 84p (FIG. 7D). In the phone-computer mode, data are directly transferred between the phone 88 and computer 8 via a wire 6 (FIG. 7E). The computer 8 has more multimedia-processing power, faster access to multimedia contents (e.g. through discs and internet) and better input/output (e.g. a large keyboard and display). When a user is not “on-the-go” (e.g. he is in his home or office), he may download multimedia contents from the computer 8 to the UMSP-phone 88, or upload the recorded data from the UMSP-phone 88 to the computer 8. Note that the wire 6 can be used to charge the phone 88. In the pHDD-device mode, if the body of an MD 84 (e.g. a digital camcorder 84v) is large, the PHDD 38 can be detached from the phone body and inserted into the MD's HDD-slot 84vs (FIG. 7F). This will enable seamless and direct data-transfer. In the phone-storage card mode, the phone 88 further comprises a slot 88s. A removable flash card 86 can be inserted into said slot 88s and performs direct data-transfer with the phone 88 (FIG. 7G). Here, the removable flash card 86 could be any of CF, MM, SD, MS or xD cards.

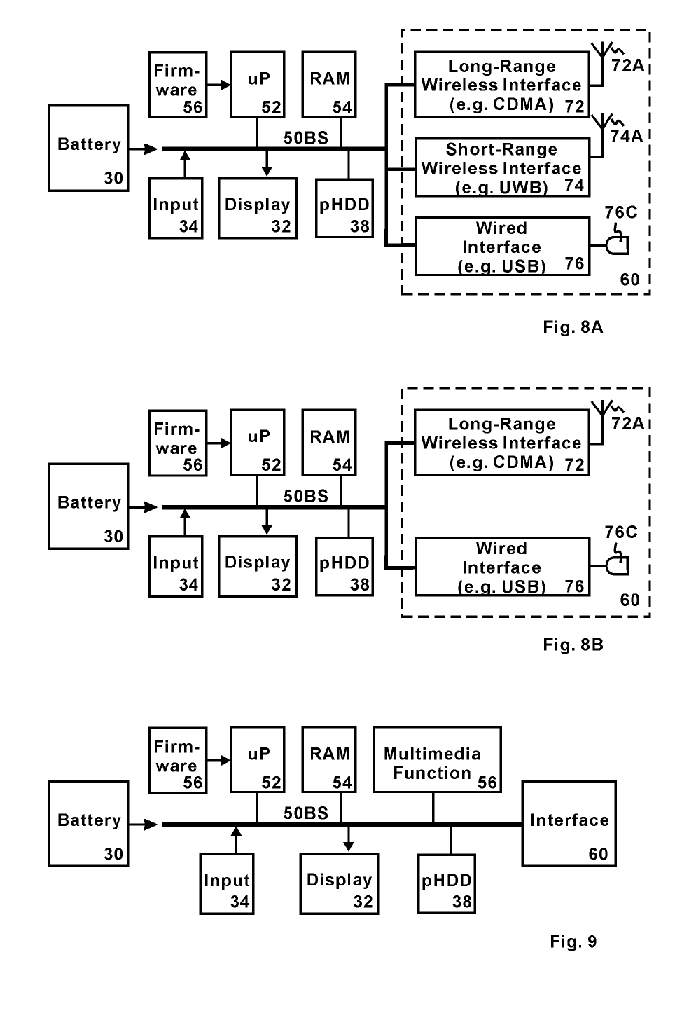

FIG. 8A is a circuit block diagram of a preferred hybrid UMSP-phone 88. Compared with FIG. 4, its interface 60 further comprises a wired interface 76 and its connector 76C. Examples of wired interface include various wired controllers (e.g. USB controller, 1394 controller, referring to FIGS. 7C-7F), various storage-card controllers (e.g. CF-card controller, MM-card controller, referring to FIG. 7G) and others.

Most high-speed, short-range wireless communication means (e.g. UWB) are still under development. Before they become commercially available, wired UMSP-phone is a practical intermediate step. Wired UMSP-phone 88 uses wired means (e.g. USB, IEEE 1394, or Ethernet) to communicate with MD. It has a similar shape as the hybrid UMSP-phone and its operation modes are similar to those in FIGS. 7C-7G. FIG. 8B is its circuit block diagram. Compared with FIG. 8A, it does not comprise short-range wireless interface.

To enable direct communication (wired or wireless), either UMSP-phone 88 or MD 84 needs to comprise a host/master function or a host-like (e.g. peer-to-peer) function. There are three scenarios: A) when the MD 84 comprises a device/slave function, the UMSP-phone 88 needs to comprise a host/master function; B) when the UMSP-phone 88 comprises a device/slave function, the MD needs to comprise a host/master function; or, C) both the MD 84 and UMSP-phone 88 comprise peer-to-peer functions. Because the UMSP-phone 88 needs to support multiple MD's, it preferably comprises at least some host function.

Besides communication, computation and storage functions, a UMSP-phone 88 may further comprise at least one multimedia function 58 (FIG. 9). It could be a recording function, a playing function, or both. For example, a UMSP-phone 88 could comprise a built-in MP3 player, which directly plays the audio files stored in the phone 88; it could also comprise a built-in digital camera, which saves photos directly onto the phone 88.

UMSP-phone combines the conventional cellular-phone with the storage device disclosed by Kobayashi et al. and Poo et al. As a result, many of their system resources (e.g. microprocessor, memory, battery, display and input) can be shared. This can significantly lower the overall system cost. In the near future, UMSP-phone will become a personal communication, computation and storage hub. Moreover, UMSP-phone may further comprise at least one multimedia function.

While illustrative embodiments have been shown and described, it would be apparent to those skilled in the art that may more modifications than that have been mentioned above are possible without departing from the inventive concepts set forth therein. The invention, therefore, is not to be limited except in the spirit of the appended claims.

What is claimed is:

1. A cellular phone as universal multimedia storage platform (UMSP-phone), comprising:
a head-disk assembly for storing data for at least a wireless multimedia device;
a high-speed, short-range wireless communication means for directly and seamlessly transferring data between said UMSP-phone and said wireless multimedia device; and
a long-range wireless communication means for performing cellular communication between said UMSP-phone and a base station.

2. The UMSP-phone according to claim 1, wherein said short-range wireless communication means has a speed no less than 1 Mb/s at the range of 10 m.

3. The UMSP-phone according to claim 2, wherein said short-range wireless communication means has a speed no less than 10 Mb/s at the range of 3 m.

4. The UMSP-phone according to claim 1, wherein said short-range wireless communication means is selected from a group of wireless means consisting of Bluetooth 2.0, UWB, wireless USB, and wireless 1394.

5. The UMSP-phone according to claim 1, wherein the local storage of said multimedia device can have a smaller capacity than the amount of data said multimedia device records or plays during a user session.

6. The UMSP-phone according to claim 1, wherein data transfer automatically starts between said UMSP-phone and said multimedia device when the amount of data in the local storage of said multimedia device reaches a pre-determined threshold.

7. The UMSP-phone according to claim 1, wherein said UMSP-phone can simultaneously communicate with at least two multimedia devices.

8. The UMSP-phone according to claim 1, wherein said head-disk assembly further stores data for at least two multimedia devices.

9. The UMSP-phone according to claim 1, further comprising a wired communication means for directly transferring data with a wired multimedia device.

10. The UMSP-phone according to claim 1, further comprising a wired communication means for directly transferring data with a computer.

11. The UMSP-phone according to claim 1, further comprising a buffer memory with a capacity no less than E_{HDA}/{P_{HDA}*(1/R_{MD}−1/R_{HDA})}, wherein E_{HDA} is the energy consumption to start said head-disk assembly, P_{HDA} is the power consumption during active read/write of said head-disk assembly, R_{MD} is the rate at which said multimedia device generates or consumes multimedia data and R_{HDA} is the rate at which said head-disk assembly reads/writes data.

12. The UMSP-phone according to claim 1, further comprising at least one multimedia function.

13. A cellular phone as universal multimedia storage (UMSP-phone), comprising:
a head-disk assembly for storing data for at least a multimedia device;
a high-speed wired communication means for directly transferring data between said UMSP-phone and said multimedia device; and
a long-range wireless communication means for performing cellular communication between said UMSP-phone and a base station.

14. The UMSP-phone according to claim 13, wherein said wired communication means is selected from a group of wired means consisting of USB, IEEE 1394, Ethernet.

15. The UMSP-phone according to claim 13, wherein said wired communication means can directly transfer data between said UMSP-phone and a computer.

16. The UMSP-phone according to claim 13, wherein said wired communication means can directly transfer data between said head-disk assembly and said multimedia device.

17. The UMSP-phone according to claim 13, wherein said wired communication means can directly transfer data between said UMSP-phone and a removable storage.

18. The UMSP-phone according to claim 17, wherein said removable storage is selected from a group of storage means consisting of removable flash card, CF card, MM card, SD card, MS card, and xD card, and videotapes.

19. The UMSP-phone according to claim 13, further comprising a high-speed, short-range wireless communication means for directly and seamlessly transferring data between said UMSP-phone and a wireless multimedia device.

20. The UMSP-phone according to claim 13, further comprising at least one multimedia function.
